(19) United States
(12) Patent Application Publication
(10) Pub. No.: US 2026/0133833 A1
(43) Pub. Date: May 14, 2026

(54) AUTOSCALING FOR MICROSERVICES BASED ON TRAFFIC PREDICTION

(71) Applicant: SAP SE, Walldorf (DE)

(72) Inventor: Hui LI, Shanghai (CN)

(21) Appl. No.: 18/944,198

(22) Filed: Nov. 12, 2024

(51) Int. Cl. G06F 9/50

(52) U.S. Cl. CPC G06F 9/5027

(57) ABSTRACT

Systems and methods include collection of workload data of a microservice for each of multiple past time instances, determination of a workload period based on the workload data, determination of a future time instance, determination of a plurality of past time instances based on the future time instance and the workload period, determination of a function based on workload data of the microservice for each of the plurality of past time instances, determination of an approximate future workload at the future time instance based on the function, and re-allocation of computing resources to the microservice based on the estimated approximate future workload.

### BACKGROUND

A microservice-based application consists of distinct functions implemented using independently-deployed microservices. A request directed to a microservice-based application is processed using several microservices, each of which executes in its own computing process in a separate computing system (e.g., server/virtual machine/container) and is independently accessible. Advantageously, each microservice of a microservice-based application may be modified and redeployed without redeploying the entire application.

Microservices are often implemented in the cloud in order to leverage the redundancy, economies of scale and other benefits provided by cloud platforms. One such benefit is resource elasticity, which allows the computing resources (e.g., CPU power, memory size, network bandwidth, and copies of executable code) consumed or used by a microservice to be efficiently scaled up and scaled down according to the needs of the microservice. For example, as CPU usage, memory usage, and/or RPS (incoming requests per second) of a microservice increase beyond a threshold, additional resources may be allocated to the microservice. Similarly, resources may be deallocated from the microservice if CPU usage, memory usage, and/or RPS decrease below a given threshold. In addition, where sufficient hardware resources are available, additional copies of executable code can be employed to provide additional software resources to meet the changing demand. Resource costs for operating the microservice may be thereby reduced in comparison to systems in which resources are fixedly allocated to serve a maximum anticipated workload.

The above approach requires time to allocate/deallocate microservice resources. Moreover, if an administrator sets predefined thresholds, future spikes or lulls may occur which might not allow for suitable resource allocation. In such cases, slow processing and/or errors may result. Systems are desired for efficient and proactive autoscaling of microservices.

### BRIEF DESCRIPTION OF THE DRAWINGS

FIG. 1 illustrates a system for resource scaling in a microservice-based system according to some embodiments.

FIG. 2 illustrates a scalable microservice according to some embodiments.

FIG. 3 is a flow diagram of a process for resource scaling at a microservice according to some embodiments.

FIG. 4 illustrates discrete values of a workload metric over time according to some embodiments.

FIG. 5 illustrates determination of a workload period according to some embodiments.

FIG. 6 illustrates determination of an approximate value of a workload metric at a future time according to some embodiments.

FIG. 7 illustrates determination of an approximate value of a workload metric at a future time according to some embodiments.

FIG. 8 illustrates a system for resource scaling in a microservice-based system according to some embodiments.

FIG. 9 illustrates a system for resource scaling in a microservice-based system according to some embodiments.

FIG. 10 illustrates a cloud-based architecture according to some embodiments.

### DETAILED DESCRIPTION

The following description is provided to enable any person in the art to make and use the described embodiments. Various modifications, however, will remain readily-apparent to those in the art.

Some embodiments facilitate proactive resource scaling in a microservices-based system based on periodic workloads. Such scaling includes estimating the workload of a microservice at a future time. To estimate the future workload, a workload period for the microservice is determined based on historical workload data of the microservice. Next, a plurality of past instances of time are determined that are related to a future point or instance in time in which resource allocation may need to be adjusted. A function is determined based on the workload data at each of the past instances of times, and an anticipated workload at a future point or instance in time is estimated based on the function. The resources associated with the microservice may then be scaled according to the expected future workload. Some embodiments may therefore initiate resource scaling at a microservice before the microservice experiences a substantive change in workload and may allow the resources of the microservice to be suitably configured for handling the changed workload by the time the workload changes. It should be noted that an instance of time may be a block of time spanning multiple time units (e.g., a past instance of time may span 1 or 5 minutes of workload data). However, these instances of time are analyzed as a group. Thus, and as an example, a 1-minute block of time may include hundreds of seconds of data, but that data is grouped together (e.g., averaged) at that group is analyzed or processed as an instance of time.

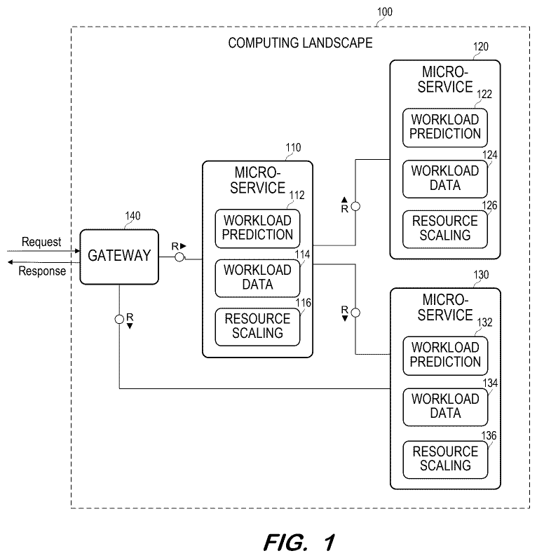

FIG. 1 illustrates a system according to some embodiments. The illustrated components of FIG. 1 may be implemented using any suitable combinations of computing hardware and/or software that are or become known. Computing landscape 100 may comprise any number of hardware and software components which provide functionality to one or more users (not shown). Such combinations may include on-premise servers, cloud-based servers, and/or elastically-allocated virtual machines. In some embodiments, two or more components are implemented by a single computing device.

Computing landscape 100 includes microservices 110, 120 and 130. Each of microservices 110, 120 and 130 may be provided by a separate execution environment (e.g., a separate process in a separate computing system). Each of microservices 110, 120 and 130 and any unshown microservices of computing landscape 100 may be a microservice of one or more microservice-based applications. Microservices 110, 120 and 130 may communicate with one another and with other unshown microservices using lightweight network communication mechanisms such as a resource Application Programming Interface (API) via Hyper Text Transfer Protocol (HTTP) request-response messages, but embodiments are not limited thereto.

The execution of one or more of microservices 110, 120 and 130 may be orchestrated to provide functionality of one or more multi-tenant applications as is known in the art. Gateway 140 receives incoming requests associated with one or more microservice-based applications and provides request routing, authentication, authorization, and load balancing. For example, gateway 140 receives an external request (e.g., an API call) associated with a microservice-based application from a client device. Gateway 140 determines a microservice of the microservice-based application to which the request should be forwarded. Gateway 140 performs required authentication and authorization functions and, if successful, the request is forwarded to the determined microservice.

The determined microservice may perform processing and transmit a request to another microservice during such processing. Similarly, the other microservice may perform processing and transmit a request to yet another microservice. A pair of microservices may exchange more than one request/response during processing of a single incoming external request. Moreover, one or more microservices may perform additional processing after receiving a response from a microservice and prior to returning a response to a requestor microservice.

Microservices 110, 120 and 130 include respective workload prediction components 112, 122 and 132. Workload prediction components 112, 122 and 132 operate to estimate approximate future workloads at their respective microservices 110, 120 and 130. Workload prediction components estimate the approximate future workloads based on respective past workload data 114, 124 and 134. The past workload data stored by a microservice includes values of one or more metrics (e.g., average CPU usage, average memory usage, RPS (incoming requests per second), average number of containers, average number of pods, etc.)) related to the workload of the microservice at several past time instances or points (i.e., time-series data).

As will be described in more detail below, the workload prediction component of a microservice determines a workload period for a microservice based on the stored workload data of the microservice. Using the determined workload period, a future time is selected for which resource reallocation may be necessary and a related plurality of past instances of time are selected and the workload data at each of those past instances of time are determined. A function is generated based on the workload data from the selected past instances of time and the approximate future workload at the future time is estimated using the generated function.

Resource scaling components 116, 126, and 136 may determine whether any computing resources allocated to respective microservices 110, 120 and 130 should be scaled (i.e., increased or decreased) in view of the estimated approximate future workload. In one example, a resource scaling component determines a resource profile based on the estimated approximate future workload, which represents a predetermined level of computing resources (e.g., CPU number and type, memory size and type, network bandwidth, containers, pods, executable code, etc.) suitable to handling the estimated approximate future workload and compares the resource profile to the current resources allocated to the microservice. The resource scaling component may then initiate scaling of the current computing resources to conform the current resources to the determined resource profile.

Scaling of resources allocated to a microservice may be performed in any manner that is or becomes known. Cloud environments generally provide systems to elastically allocate computing resources to virtual machines based on demand. Microservices are often deployed in containers managed by a container orchestration platform which provides efficient autoscaling.

Computing landscape 100 may comprise a cloud-native system utilizing a Kubernetes cluster. Kubernetes is an open-source system for automating deployment, scaling, and management of containerized applications. Each component of computing landscape 100 may therefore be implemented by one or more servers (real and/or virtual) or containers.

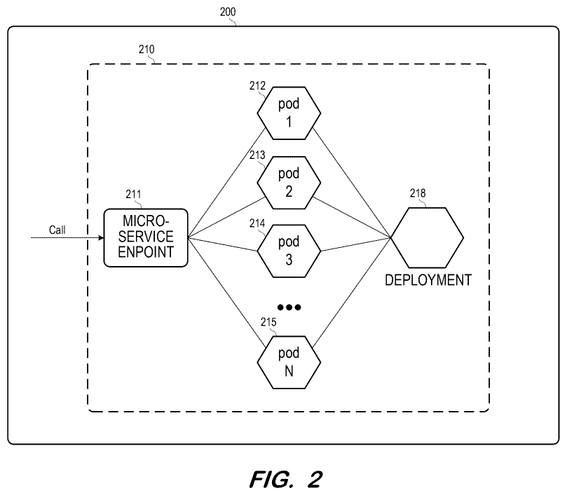

FIG. 2 illustrates microservice 210 deployed in container orchestration platform 200 such as but not limited to Kubernetes. Microservice 210 may comprise an implementation of any of microservices 110, 120 and 130 according to some embodiments. Microservice 210 contains nodes 220 and 230, which are virtual or physical machines as is known in the art. Microservice 210 may include one or any number of nodes.

Each of nodes 220 and 230 executes one or more pods, which are collections of one or more containers. Node 220 is shown with N pods 222-225, each of which may independently provide the functionality of microservice 210. According to some embodiments, microservice endpoint 211 receives a call from another microservice and routes the call to one of nodes 220 or 230 for processing thereof.

Deployment component 218 may adjust the number of pods, the number of nodes and/or the computing resources of each node based on the estimated future workload of microservice 210. For example, if the estimated approximate future workload is greater than a first threshold, deployment 218 may create one or more additional pods in one or both of nodes 220, 230. If the estimated approximate future workload is less than a second threshold, deployment 218 may terminate one or more of pods 222-225.

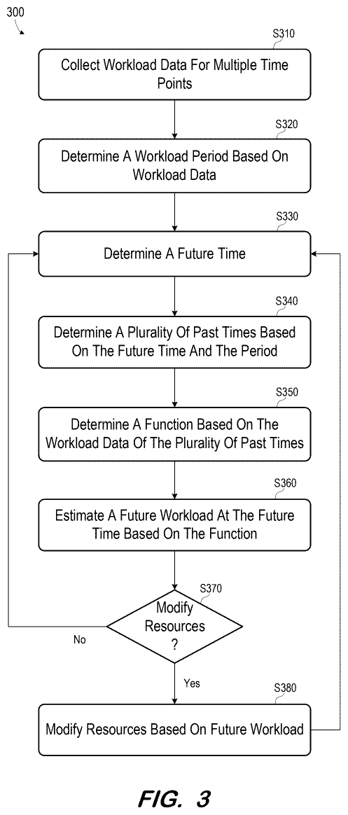

FIG. 3 is a flow diagram of process 300 for resource scaling at a microservice according to some embodiments. Process 300 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Prior to S310 it is assumed that a microservice is operating in a test, development or productive landscape. Accordingly, the microservice receives and responds to requests as it is configured to operate in the landscape. The requests constitute a workload which is associated with any number of workload metrics by which the extent of the workload may be represented. The microservice may include a monitoring service to determine values of one or more of such workload metrics at various time intervals.

The workload metric values, or workload data, are collected at S310 for multiple time instances or points over the course of operation of the microservice. Examples of the workload metrics include but are not limited to percentage of CPU usage, incoming requests per second, average memory usage, average number of pods, average number of nodes, amount of executable code, etc. In one example, microservice 110 collects and stores the workload data in workload data 114.

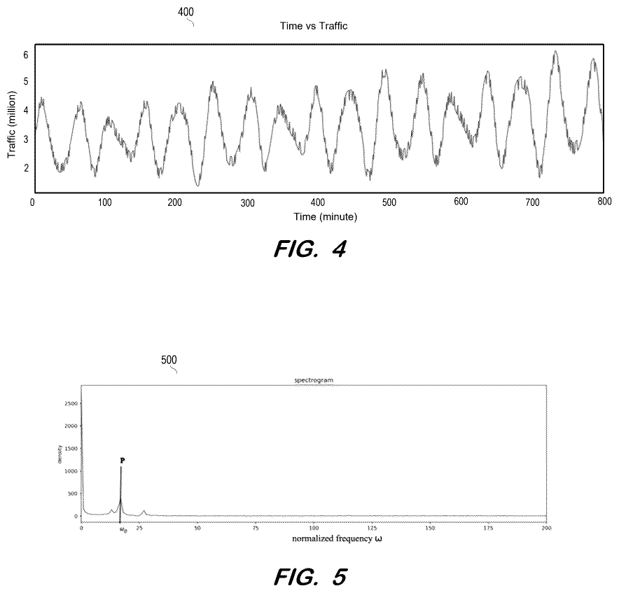

A workload period is determined at S320 based on the workload data. FIG. 4 shows graph 400 of workload data collected at S310 according to some embodiments. Graph 400 illustrates values (in millions) of requests per second for each minute of an 800-minute timeframe. Accordingly, although graph 400 appears to depict continuous values due to its scale, the values depicted therein are discrete (i.e., one value per minute). Graph 400 shows that the values change over time according to an imperfect cyclical pattern. It should also be noted that an 800 minute timespan is shown, other time spans, such as 1,440 minutes, are also contemplated within the scope of this description. Sufficient data points, and therefore an appropriate time span, should be selected to give sufficient data to analyze and make reasonable predictions.

In order to determine a period of the workload data, some embodiments first determine the relative signal strength of different normalized frequencies (i.e., different harmonic periods) of the time-series workload data.

According to the formula of the Discrete Fourier Transform (DFT), DFT F(k) of discrete signals s(n) is:

$$F ( k ) = {\sum }_{n = 0}^{N - 1} s ( n ) {e}^{- j 2 π kn / N}$$

where j is an imaginary number unit and j²=−1, N is the count of signals s(n) (which should be large enough to span several periods), which can be interpreted as the count of harmonic periods in the signals. It should be noted that any number of DFT or Fast Fourier Transform (FFT) algorithms may be used to obtain the frequency spectrum. In some embodiments, the density of the Fourier transform can also be calculated.

FIG. 5 shows spectrogram 500 of Density(ω) at scope ω>0 according to some embodiments. The time-series workload data (i.e., the discrete signal of spectrogram 500) exhibits maximum strength density at peak point P. The dominant frequency ω₀ corresponding to point P is the most prevalent harmonic in the signal and may be used to represent the number of periods of that harmonic. Consequently, the workload period T can be calculated at S320 by:

$$T = \frac{2 π}{{ω}_{0}}$$

$$Since ω = 0. 13 ,$$

$$T = \frac{2 π}{0.13} \approx 48 ( minutes )$$

A future time is determined at S330. The future time may be any time for which a determination of an estimated approximate workload is desired. The future time may be far enough in the future to give the microservice adequate time to react to significant macro-level workload changes, but not so far as to risk significant changes to the current cyclical pattern of the workload (e.g., relatively micro-level workload changes). In other words, additional capacity can be added or subtracted by observing a long-term trend (i.e., macro-level) while allowing for other mechanisms to provide capacity adjustments using a more reactive approach on a smaller time scale (i.e., micro-level). According to some embodiments, several future times are determined at S330 in order to estimate the approximate future workload at each of the several future times.

At S340, a plurality of past time instances are determined based on the future time determined at S330 and the period determined at S320. The plurality of past time instances are times which occurred at roughly the same phase of the workload period at which the future time will occur. Assuming the future time is denoted t₁, the plurality of past times may be determined as t₋₁=t₁−T, t₋₂=t₁−2T, t₋₃=t₁-3T . . . , t_{-M}=t₁−MT. Graph 600 shows times t₁−T, t₁−2T, t₁−MT which may be determined at S340 according to some embodiments.

Next, at S350, a function is determined based on the workload data of the plurality of past time instances workload data. Graph 600 shows the function as a line fit to the discrete workload metric values associated with each of times t₁−T, t₁−2T, t₁−MT. The line is represented by:

$$f ( t ) = a \times t + b$$

Embodiments are not limited to a linear fitting function. Any suitable polynomial function may be utilized at S350.

In some embodiments, a, b are calculated by a least squares method. First, a vector of past time instances or points associated with future time t₁ is defined, with M as a configurable value:

$$[ {t}_{1}^{( 1 )} , {t}_{1}^{( 2 )} , … , {t}_{1}^{( M )} ] = [ {t}_{1} - T , {t}_{1} - 2 T , … , {t}_{1} - M \times T ]$$

A vector for past workload data for the past time instances or points is defined as:

$$[ {f}_{1}^{( 1 )} , {f}_{1}^{( 2 )} , … , {f}_{1}^{( M )} ] = [ f ( {t}_{1} - T ) , f ( {t}_{1} - 2 T ) , … , f ( {t}_{1} - M \times T ) ]$$

and a, b are calculated by the least squares method as:

$$a = \frac{M \times {\sum }_{i = 1}^{M} ( {t}_{1}^{( i )} \times {f}_{1}^{( i )} ) - {\sum }_{i = 1}^{M} {t}_{1}^{( i )} \times {\sum }_{i = 1}^{M} {f}_{1}^{( i )}}{M \times {\sum }_{i = 1}^{M} {( {t}_{1}^{( i )} )}^{2} - {( {\sum }_{i = 1}^{M} {t}_{1}^{( i )} )}^{2}}$$

$$b = \frac{1}{M} \times {\sum }_{i = 1}^{M} ( {f}_{1}^{( i )} - a \times {t}_{1}^{( i )} )$$

The line f(t)=a×t+b is thereby fitted to the M points

$$( {t}_{1}^{( 1 )} , {f}_{1}^{( 1 )} ) , ( {t}_{1}^{( 2 )} , {f}_{1}^{( 2 )} ) , … , ( {t}_{1}^{( M )} , {f}_{1}^{( M )} )$$

of graph 400.

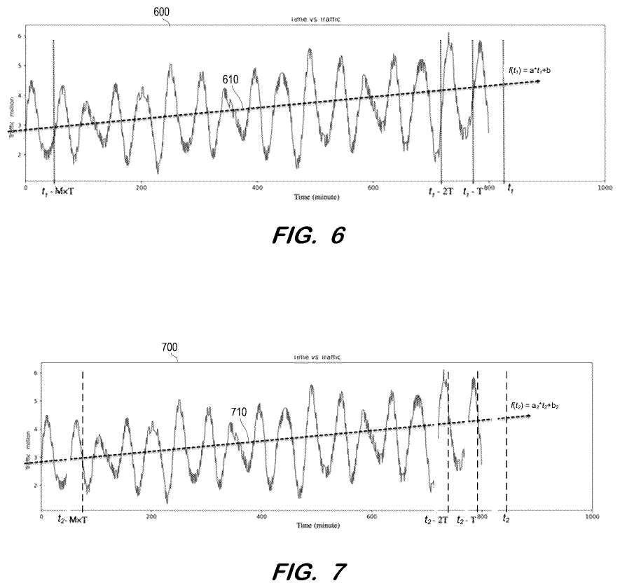

Based on the function, a future workload at the future time is estimated at S360. FIG. 6 depicts line 610 representing a function determined based on the workload metric values associated with each of times t₁−T, t₁−2T, t₁−MT. S360 may comprise determination of the value of line 610 at time t₁. This value may be determined by evaluating f(t₁)=a×t₁+b using t₁ and the previously-determined values of a, b.

At S370, it is determined whether to modify the computing resources of the microservice based on the estimated future workload. The determination may comprise a determination to initiate modification of computing resources immediately and/or at a future time. The determination at S370 may be based on a resource profile associating various estimated future workloads with respective predetermined allocations of computing resources (e.g., CPU number and type, memory size and type, network bandwidth) which are deemed suitable to handling the estimated future workload.

Flow continues to S380 if it is determined to modify computing resources. The computing resources allocated to the microservice are modified based on the future workload at S380, using any suitable resource scaling component.

Flow returns to S330 if it is determined at S370 to not modify the resources allocated to the microservice, or after modification of the allocated resources at S380. At S330, another future time (or future times) for which to estimate a workload is determined. Flow proceeds through S370 as described above with respect to the future time(s). Since the plurality of past times determined at S340 will likely differ from the previous iteration, the function determined at S350 will likely also differ. Plot 700 of FIG. 7 illustrates a second plurality of past times determined at S340 based on a future time t₂ which is different from t₁ of FIG. 6, and line 710 which represents a second function determined at S350 based on the workload data of each of the second plurality of past times.

If multiple future times are determined at S330, a plurality of past times are determined for each of the multiple future times at S340. With reference to the above example, a different function is determined for each future time at S350, resulting in coefficients a₁, b₁ for a function corresponding to a first future time t₁, coefficients a₂, b₂ for a function corresponding to a second future time t₂, coefficients a₃, b₃ for a function corresponding to a third future time t₃, etc. A future workload for each future time is determined based on the functions and the determination of whether to modify the allocated resources may be based on all the determined future workloads. Such an implementation may allow improved resource allocation.

The workload period of a microservice may change over time. Accordingly, some embodiments may periodically execute S310 and S320 to refresh the workload period based on which the future workloads are estimated. In some embodiments, the period may be continuously monitored and updated. The workload period may be updated in response to operational data of a microservice landscape such as statistics indicating a change in workload distribution, removal or addition of a microservice, or the like.

The workload periods of the microservices within a landscape may differ from one another in duration and/or phase. These differences may be leveraged to modify the allocation of the computing resources of the landscape over time and at a global level. For example, computing resources may be de-allocated from services that are entering a descending range of their workload periods and allocate those resources to services that are entering an ascending range of their workload periods.

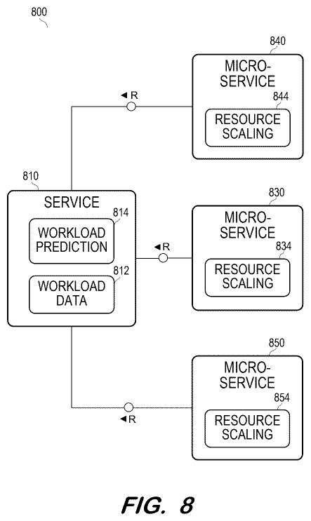

FIG. 8 illustrates resource scaling within multiple microservices in microservice-based system 800 according to some embodiments. System 800 includes service 810 to collect workload data 812 from microservices 830, 840, 850 over time. Service 810 also includes workload prediction component 814 to estimate future workloads as described above.

According to the illustrated embodiment, microservices 830, 840, 850 may selectively request their respective future workloads from service 810. The requests may specify a future time for which the future workload should be estimated. In response to a request, service 810 uses prediction component 814 and workload data 812 associated with the requesting microservice to determine an estimated future workload for the microservice as described with respect to S310-S360 and returns the estimated future workload to the microservice.

The resource scaling component of the microservice may then determine whether to allocate resources to or de-allocate resources from the microservice based on the estimated future workload. Resource scaling components 834, 844, 854 may be governed by different scaling rules. For instance, a given estimated future workload at microservice 840 may result in an increase in allocated memory, while the same estimated future workload at microservice 850 may result in no change to allocated resources, or in a different change to a different resource allocation.

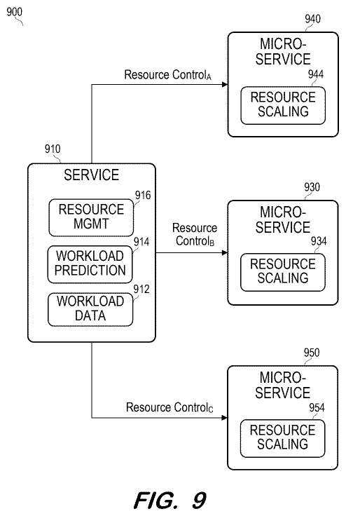

FIG. 9 illustrates resource scaling within multiple microservices in microservice-based system 900 according to some embodiments. Service 910 of system 900 collects workload data 912 from microservices 930, 940, 950 and includes workload prediction component 914 as described above. Service 910 also includes resource management component 916 to manage computing resources allocated to microservices 930, 940 and 950.

For example, workload prediction component 914 may periodically determine an estimated future workload for each of microservices 930, 940, 950 based on their respective workload data 912. Based on the estimated future workloads, resource management component 916 may determine that computing resources should be allocated to or de-allocated from one or more of microservices 930, 940, 950. Alternatively, resource management component 916 may determine, based on the estimated future workloads, an overall allocation of computing resources for microservices 930, 940, 950. In either case, the determination may be based rules or guidelines (not shown) which are specific to each microservice and known to resource management component 916.

Based on these determinations, resource management component 916 may provide a resource control instruction to one or more of microservices 930, 940, 950 to control the resource allocation thereof. The resource control instruction may, for example, instruct a respective resource scaling component 934, 944, 954 to perform microservice-specific resource allocations and/or de-allocations. In another example, a resource control instruction indicates a desired allocation of computing resources and each respective resource scaling component 934, 944, 954 determines whether to allocate and/or de-allocate resources based on the desired resource allocation.

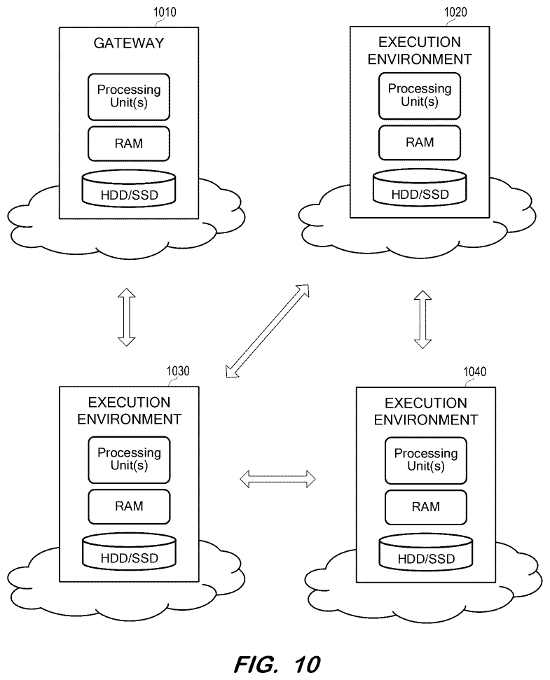

FIG. 10 illustrates a cloud-based deployment according to some embodiments. The illustrated components may comprise cloud-based computing resources residing in one or more public clouds providing self-service and immediate provisioning, autoscaling, security, compliance and identity management features.

Execution environments 1010-1040 may comprise servers or virtual machines of a Kubernetes cluster. Execution environments 1010-1040 may support containerized applications which provide one or more services to users. Execution environment 1010 may execute a gateway and execution environments 1020-1040 may execute microservices of a microservice-based application as described herein.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of networks and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing executable program code; and
one or more processing units to execute the executable program code to cause the system to:
collect workload data of a microservice for each of multiple past time instances;
determine a workload period based on the workload data;
determine a future time instance;
determine a plurality of past time instances based on the future time instance and the workload period;
determine a function based on workload data of the microservice for each of the plurality of past time instances;
determine an approximate future workload at the future time instance based on the function; and
re-allocate computing resources to the microservice based on the approximate future workload.

2. A system according to claim 1, the one or more processing units to execute the executable program code to cause the system to:
determine a second future time instance;
determine a second plurality of past time instances based on the second future time instance and the workload period;
determine a second function based on workload data of the microservice for each of the second plurality of past time instances; and
determine a second approximate future workload at the second future time instance based on the function,
wherein the computing resources to the microservice are re-allocated based on the approximate future workload and the second approximate future workload.

3. A system according to claim 2, the one or more processing units to execute the executable program code to cause the system to:
collect second workload data of the microservice for each of second multiple past time instance;
determine a second workload period based on the second workload data;
determine a third future time instance;
determine a third plurality of past time instances based on the third future time instance and the second workload period;
determine a third function based on workload data of the microservice for each of the third plurality of past time instances;
determine a third approximate future workload at the third future time instance based on the third function; and
re-allocate computing resources to the microservice based on the third approximate future workload.

4. A system according to claim 1, the one or more processing units to execute the executable program code to cause the system to:
collect second workload data of the microservice for each of second multiple past time instances;
determine a second workload period based on the second workload data;
determine a second future time instance;
determine a second plurality of past time instance based on the second future time instance and the second workload period;
determine a second function based on workload data of the microservice for each of the second plurality of past time instances;
determine a second approximate future workload at the second future time instance based on the second function; and
re-allocate computing resources to the microservice based on the second approximate future workload.

5. A system according to claim 1, wherein determination of the workload period comprises determination of a normalized frequency of a highest-energy harmonic of a time-series signal of the workload data for each of the multiple past time instances.

6. A system according to claim 1, wherein determination of the plurality of past time instances based on the future time instance and the workload period comprises determination of the plurality of past time instances which occur at a same phase of the workload period as the future time instance.

7. A system according to claim 2, wherein determination of the plurality of past time instances based on the future time instance and the workload period comprises determination of the plurality of past time instances which occur at a same phase of the workload period as the future time instance, and
wherein determination of the second plurality of past time instances based on the second future time instance and the workload period comprises determination of the second plurality of past time instances which occur at a same phase of the workload period as the second future time instance.

8. A method comprising:
collecting workload data of a microservice for each of multiple past time instances;
determining a workload period based on the workload data;
determining a future time instance;
determining a plurality of past time instances based on the future time instance and the workload period;
determining a function based on workload data of the microservice for each of the plurality of past time instances;
determining an approximate future workload at the future time instance based on the function; and
transmitting a signal to allocate computing resources based on the approximate future workload.

9. A method according to claim 8, further comprising:
determining a second future time instance;
determining a second plurality of past time instances based on the second future time instance and the workload period;
determining a second function based on workload data of the microservice for each of the second plurality of past time instances; and
determining a second approximate future workload at the second future time instance based on the second function,
wherein the computing resources are allocated based on the approximate future workload and the second approximate future workload.

10. A method according to claim 9, further comprising:
collecting second workload data of the microservice for each of second multiple past time instances;
determining a second workload period based on the second workload data;
determining a third future time instance;
determining a third plurality of past time instances based on the third future time point and the second workload period;
determining a third function based on workload data of the microservice for each of the third plurality of past time instances;
determining a third approximate future workload at the third future time instance based on the third function; and
transmitting a second signal to allocate the computing resources based on the third approximate future workload.

11. A method according to claim 8, further comprising:
collecting second workload data of the microservice for each of second multiple past time instances;
determining a second workload period based on the second workload data;
determining a second future time instance;
determining a second plurality of past time instances based on the second future time instance and the second workload period;
determining a second function based on workload data of the microservice for each of the second plurality of past time instances;
determining a second approximate future workload at the second future time instance based on the second function; and
transmitting a second signal to allocate the computing resources based on the second approximate future workload.

12. A method according to claim 8, wherein determining the workload period comprises determining a normalized frequency of a highest-energy harmonic of a time-series signal of the workload data for each of the multiple past time instances.

13. A method according to claim 8, wherein determining the plurality of past time instances based on the future time instance and the workload period comprises determining the plurality of past time instances which occur at a same phase of the workload period as the future time instance.

14. A method according to claim 9, wherein determining the plurality of past time instances based on the future time instance and the workload period comprises determining the plurality of past time instances which occur at a same phase of the workload period as the future time instance, and
wherein determining the second plurality of past time instances based on the second future time instance and the workload period comprises determining the second plurality of past time instances which occur at a same phase of the workload period as the second future time instance.

15. A non-transitory medium storing program code executable by a processing unit of a computing system to:
collect workload data for each of multiple past time instances;
determine a workload period based on the workload data;
determine a future time instance;
determine a plurality of past time instances based on the future time instance and the workload period;
determine a function based on workload data for each of the plurality of past time instances; and
determine an approximate future workload at the future time instance based on the function.

16. A medium according to claim 15, the program code executable by a processing unit of a computing system to:
determine a second future time instance;
determine a second plurality of past time instances based on the second future time instance and the workload period;
determine a second function based on workload data for each of the second plurality of past time instances; and
determine a second approximate future workload at the second future time instance based on the function.

17. A medium according to claim 16, the program code executable by a processing unit of a computing system to:
collect second workload data for each of second multiple time instances;
determine a second workload period based on the second workload data;
determine a third future time instance;
determine a third plurality of past time instances based on the third future time instance and the second workload period;
determine a third function based on workload data for each of the third plurality of past time instances; and
determine a third future workload at the third future time instance based on the third function.

18. A medium according to claim 15, the program code executable by a processing unit of a computing system to:
collect second workload data for each of second multiple past time instances;
determine a second workload period based on the second workload data;
determine a second future time instance;
determine a second plurality of past time instances based on the second future time instance and the second workload period;
determine a second function based on workload data for each of the second plurality of past time instances; and
determine a second approximate future workload at the second future time instance based on the second function.

19. A medium according to claim 15, wherein determination of the workload period comprises determination of a normalized frequency of a highest-energy harmonic of a time-series signal of the workload data for each of the multiple past time instances.

20. A medium according to claim 19, wherein determination of the plurality of past time instances based on the future time point and the workload period comprises determination of the plurality of past time instances which occur at a same phase of the workload period as the future time instance.
